(19) United States
(12) Patent Application Publication
(10) Pub. No.: US 2026/0118632 A1
(43) Pub. Date: Apr. 30, 2026

(54) OPTICAL IMAGING SYSTEM

(71) Applicant: Samsung Electro-Mechanics Co., Ltd., Suwon-si (KR)

(72) Inventors: Ji Su LEE, Suwon-si (KR); Jae Hyuk HUH, Suwon-si (KR); Yong Joo JO, Suwon-si (KR)

(73) Assignee: Samsung Electro-Mechanics Co., Ltd., Suwon-si (KR)

(21) Appl. No.: 19/084,999

(22) Filed: Mar. 20, 2025

(30) Foreign Application Priority Data
Oct. 29, 2024 (KR) 10-2024-0149375

(51) Int. Cl. G02B 9/64; G02B 13/18

(52) U.S. Cl. CPC G02B 9/64; G02B 13/18

(57) ABSTRACT

An optical imaging system includes a first lens having refractive power, a second lens having positive refractive power, a third lens having negative refractive power, a fourth lens, a fifth lens, a sixth lens, a seventh lens, and an eighth lens, sequentially disposed from an object side. The first lens and the second lens are bonded together, wherein 0≤|f1/v1−f2/v2|<3 is satisfied, where f1 is a focal length of the first lens, v1 is an Abbe number of the first lens, f2 is a focal length of the second lens, and v2 is an Abbe number of the second lens.

### CROSS-REFERENCE TO RELATED APPLICATION(S)

This application claims the benefit under 35 USC 119(a) of Korean Patent Application No. 10-2024-0149375 filed on Oct. 29, 2024, in the Korean Intellectual Property Office, the entire disclosure of which is incorporated herein by reference for all purposes.

### BACKGROUND

### 1. Field

The present disclosure relates to an optical imaging system.

### 2. Description of the Background

Portable terminals may be equipped with cameras with high resolution that include an optical imaging system comprising a plurality of lenses to enable video calls and image capturing.

Image sensors with high pixels (e.g., 13 million to 200 million pixels) may be adopted in cameras for portable terminals in order to realize clearer image quality.

Additionally, as portable terminals are gradually becoming smaller, slimmer cameras for portable terminals may be desired.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens having refractive power, a second lens having positive refractive power, a third lens having negative refractive power, a fourth lens, a fifth lens, a sixth lens, a seventh lens, and an eighth lens, sequentially disposed from an object side. The first lens and the second lens are bonded together, wherein 0≤|f1/v1−f2/v2|<3 is satisfied, where f1 is a focal length of the first lens, v1 is an Abbe number of the first lens, f2 is a focal length of the second lens, and v2 is an Abbe number of the second lens.

The Abbe number of the first lens may be lower than the Abbe number of the second lens.

A refractive index of the first lens may be higher than a refractive index of the second lens.

The third lens may have a convex object-side surface and a concave image-side surface.

The fourth lens may have a convex object-side surface, and the sixth lens may have a concave image-side surface.

The seventh lens may have positive refractive power and a convex object-side surface.

The eighth lens may have negative refractive power and a convex object-side surface.

The optical imaging system, wherein 1<TTL/f<1.3 may be satisfied, where f is a total focal length of the optical imaging system, and TTL is a distance on an optical axis from an object-side surface of the first lens to an imaging plane.

The optical imaging system, wherein 0.5<TTL/(2×IMG HT)<0.8 may be satisfied, where IMG HT is a half of a diagonal length of an imaging plane, and TTL is a distance along an optical axis from an object-side surface of the first lens to an imaging plane.

In another general aspect, an optical imaging system includes a first lens, a second lens, a third lens, a fourth lens, a fifth lens, a sixth lens, a seventh lens, and an eighth lens, sequentially arranged from an object side, wherein the first lens and the second lens are bonded together, and wherein either one or both of v1−v2<0 and 0<n1−n2 are satisfied, where v1 is an Abbe number of the first lens, v2 is an Abbe number of the second lens, n1 is a refractive index of the first lens, and n2 is a refractive index of the second lens.

The optical imaging system, wherein 0<f2/f<2 may be satisfied, where f is a total focal length of the optical imaging system, and f2 is a focal length of the second lens.

The optical imaging system, wherein −5<f3/f<−1 may be satisfied, where f is a total focal length of the optical imaging system, and f3 is a focal length of the third lens.

The optical imaging system, wherein −10<f4/f/100<1 may be satisfied, where f is a total focal length of the optical imaging system, and f4 is a focal length of the fourth lens.

The optical imaging system, wherein −5<f5/f/100<1 may be satisfied, where f is a total focal length of the optical imaging system, and f5 is a focal length of the fifth lens.

The optical imaging system, wherein 0<f7/f<2 may be satisfied, where f is a total focal length of the optical imaging system, and f7 is a focal length of the seventh lens.

The optical imaging system, wherein −2<f8/f<0 may be satisfied, where f is a total focal length of the optical imaging system, and f8 is a focal length of the eighth lens.

Other features and aspects will be apparent from the following detailed description, the drawings, and the claims.

### BRIEF DESCRIPTION OF DRAWINGS

FIG. 1A is a configuration diagram of an optical imaging system according to a first embodiment of the present disclosure.

FIG. 1B is a diagram illustrating aberration characteristics of the optical imaging system illustrated in FIG. 1A.

FIG. 2A is a configuration diagram of an optical imaging system according to a second embodiment of the present disclosure.

FIG. 2B is a diagram illustrating aberration characteristics of the optical imaging system illustrated in FIG. 2A.

FIG. 3A is a configuration diagram of an optical imaging system according to a third embodiment of the present disclosure.

FIG. 3B is a diagram illustrating aberration characteristics of the optical imaging system illustrated in FIG. 3A.

FIG. 4A is a configuration diagram of an optical imaging system according to a fourth embodiment of the present disclosure.

FIG. 4B is a diagram illustrating aberration characteristics of the optical imaging system illustrated in FIG. 4A.

FIG. 5A is a configuration diagram of an optical imaging system according to a fifth embodiment of the present disclosure.

FIG. 5B is a diagram illustrating aberration characteristics of the optical imaging system illustrated in FIG. 5A.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In the present specification, a first lens refers to a lens closest to an object side, and an eighth lens refers to a lens closest to an imaging plane (or an image sensor).

In addition, in the present specification, values for a radius of curvature, a thickness, a distance, a focal length, or the like of a lens are all in mm, and a unit of a field-of-view (FOV) is a degree.

In addition, in the description of a shape of a lens, a configuration in which one surface is convex indicates that a paraxial region (a very narrow region near the optical axis) of the one surface is convex, and a configuration in which one surface is concave indicates that a paraxial region of the one surface is concave. Therefore, even if one surface of a lens is described as having a convex shape, an edge portion of the lens may be concave, and likewise, even if one surface of a lens is described as having a concave shape, an edge portion of the lens may be convex.

An optical imaging system according to an embodiment of the present disclosure may include eight lenses.

For example, an optical imaging system according to an embodiment of the present disclosure may include a first lens, a second lens, a third lens, a fourth lens, a fifth lens, a sixth lens, a seventh lens, and an eighth lens, sequentially disposed from an object side.

However, the optical imaging system according to an embodiment of the present disclosure may not consist only of eight lenses, and may further include other components, as needed. For example, the optical imaging system may further include an image sensor converting an incident light of a subject into an electrical signal. Additionally, the optical imaging system may further include an infrared blocking filter (hereinafter, ‘filter’) blocking light within the infrared region incident on the image sensor. Additionally, the optical imaging system may further include a stop for controlling an amount of light.

The first lens configuring the optical imaging system according to embodiments of the present disclosure may be a lens formed of a polymer material (a material which is distinct from the following plastic material), and for example, may have adhesiveness. For example, the first lens may be a liquid UV polymer having a characteristic of solidifying in response to UV. Additionally, the second to eighth lenses configuring the optical imaging system according to embodiments of the present disclosure may be lenses formed of plastic or glass material. For example, the second lens may be a lens formed of plastic or glass material, and the third to eighth lenses may be lenses formed of a plastic material.

In addition, at least one lens among the first to eighth lenses may have an aspherical surface. For example, the first to eighth lenses may each have at least one aspherical surface. The aspherical surfaces of the first to eighth lenses are expressed by Equation 1:

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} … \qquad Equation 1$$

In Equation 1, c is a curvature (reciprocal of a radius of curvature) of a lens, K is a conic constant, and Y represents a distance from a certain point on an aspherical surface of the lens to an optical axis. In addition, the constants A˜P refer to an aspheric coefficient and Z (SAG) represents a distance in an optical axis direction between the certain point on the aspherical surface of the lens and a vertex of the aspherical surface.

An optical imaging system according to an embodiment of the present disclosure may satisfy any one or any two or more of the conditional expressions below:

$$0 \leq \vert f 1 / v 1 - f 2 / v 2 \vert < 3 ; \qquad [ Conditional Expression 1 ]$$

$$v 1 - v 2 < 0 ; \qquad [ Conditional Expression 2 ]$$

$$0 < n 1 - n 2 ; \qquad [ Conditional Expression 3 ]$$

$$- 2 < f 1 / f / 10 < 2 ; \qquad [ Conditional Expression 4 ]$$

$$0 < f 2 / f < 2 ; \qquad [ Conditional Expression 5 ]$$

$$- 5 < f 3 / f < - 1 ; \qquad [ Conditional Expression 6 ]$$

$$- 10 < f 4 / f / 100 < 1 ; \qquad [ Conditional Expression 7 ]$$

$$- 5 < f 5 / f / 100 < 1 ; \qquad [ Conditional Expression 8 ]$$

$$- 8 < f 6 / f < 8 ; \qquad [ Conditional Expression 9 ]$$

$$0 < f 7 / f < 2 ; \qquad [ Conditional Expression 10 ]$$

$$- 2 < f 8 / f < 0 ; \qquad [ Conditional Expression 11 ]$$

$$0.5 < TTL / ( 2 XIMG HT ) < 0.8 ; \qquad [ Conditional Expression 12 ]$$

$$1 < f / EPD < 3 ; \qquad [ Conditional Expression 13 ]$$

$$1 < TTL / f < 1.3 ; and \qquad [ Conditional Expression 14 ]$$

$$0.1 < BFL / f < 0.3 . \qquad [ Conditional Expression 15 ]$$

In the conditional expressions, f is a total focal length of the optical imaging system, f1 is a focal length of the first lens, f2 is a focal length of the second lens, f3 is a focal length of the third lens, f4 is a focal length of the fourth lens, f5 is a focal length of the fifth lens, f6 is a focal length of the sixth lens, f7 is a focal length of the seventh lens, and f8 is a focal length of the eighth lens.

Additionally, v1 is an Abbe number of the first lens, v2 is an Abbe number of the second lens, n1 is a refractive index of the first lens, and n2 is a refractive index of the second lens.

Additionally, TTL is a distance on an optical axis from an object-side surface of the first lens to an imaging plane, BFL is a distance on the optical axis from an image-side surface of the eighth lens to the imaging plane, IMG HT is half the diagonal length of the imaging plane, and EPD is a diameter of an entrance pupil.

The first lens and the second lens configuring an optical imaging system according to embodiments of the present disclosure may be bonded lenses, e.g. the first lens and the second lens may be bonded together. The first lens and the second lens may be lenses formed of different materials. For example, the first lens may be a lens formed of a polymer material (a material distinct from the plastic material described below), and the second lens may be a lens formed of a plastic or glass material. Furthermore, the first lens may be formed of an adhesive material, and thus may be directly attached to an object-side surface of the second lens without using an additional adhesive.

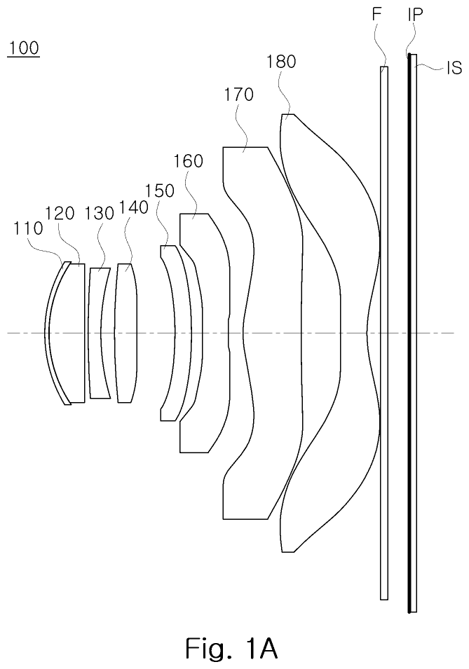

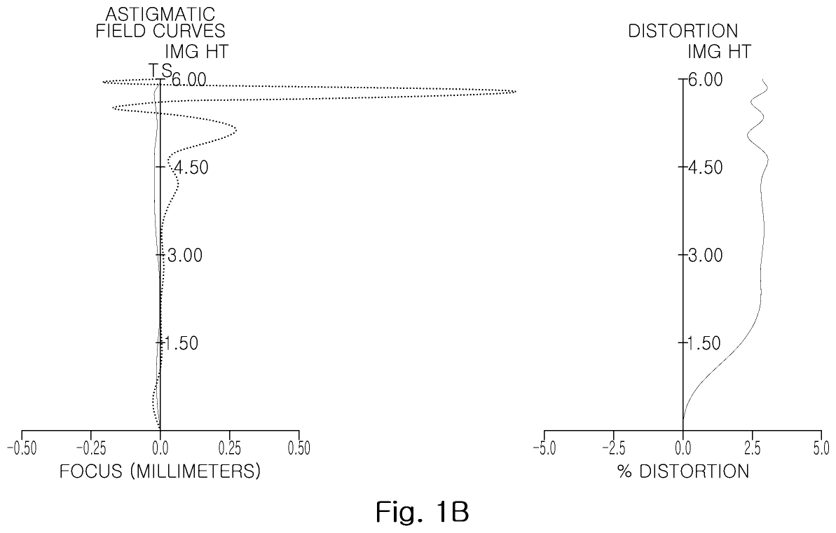

FIG. 1A is a configuration diagram of an optical imaging system according to a first embodiment of the present disclosure, and FIG. 1B is a diagram illustrating aberration characteristics of an optical imaging system illustrated in FIG. 1A.

An optical imaging system 100 according to the first embodiment of the present disclosure may include a first lens 110, a second lens 120, a third lens 130, a fourth lens 140, a fifth lens 150, a sixth lens 160, a seventh lens 170, and an eighth lens 180, sequentially disposed from an object side, and an image sensor IS having a filter F and an imaging plane IP on which a focus is formed.

A total focal length f of the optical imaging system 100 according to the first embodiment of the present disclosure is 6.06 mm, IMG HT is 6.00 mm, and FOV is 87.8°.

The characteristics of each lens configuring the optical imaging system 100 according to the first embodiment of the present disclosure are illustrated in Table 1.

TABLE 1

| Surface | | Curvature | Thickness/ | Refractive | Abbe | Focal |
|---|---|---|---|---|---|---|
| No. | Component | Radius | Distance | Index | No. | length |
| S1 | 1st Lens | 3.0017 | 0.1000 | 1.651 | 39.25 | −85.89 |
| S2 | 2nd Lens | 2.8120 | 0.7022 | 1.617 | 60.47 | 4.94 |
| S3 | | 31.2733 | 0.1015 | | | |
| S4 | 3rd Lens | 48.5674 | 0.2620 | 1.679 | 31.53 | −9.26 |
| S5 | | 5.5887 | 0.2825 | | | |
| S6 | 4th Lens | 10.9567 | 0.4762 | 1.591 | 61.93 | 10.61 |
| S7 | | −14.5721 | 0.7849 | | | |
| S8 | 5th Lens | −9.3580 | 0.3472 | 1.681 | 31.81 | 30.35 |
| S9 | | −6.5541 | 0.1884 | | | |
| S10 | 6th Lens | −19.1739 | 0.5464 | 1.635 | 23.96 | −6.03 |
| S11 | | 4.8992 | 0.3134 | | | |
| S12 | 7th Lens | 3.4961 | 1.1723 | 1.567 | 37.40 | 5.60 |
| S13 | | −32.7086 | 0.8036 | | | |
| S14 | 8th Lens | 48.6290 | 0.5355 | 1.535 | 55.74 | −5.59 |
| S15 | | 2.8167 | 0.2799 | | | |
| S16 | Filter | Infinity | 0.1540 | 1.517 | 64.20 | |
| S17 | | Infinity | 0.4451 | | | |
| S18 | Imaging | Infinity | | | | |
| | Plane | | | | | |

According to the first embodiment of the present disclosure, the first lens 110 may have negative refractive power, an object-side surface may be convex, and an image-side surface may be concave. The second lens 120 may have positive refractive power, an object-side surface may be convex, and an image-side surface may be concave. The third lens 130 may have negative refractive power, an object-side may be convex, and an image-side surface may be concave. The fourth lens 140 may have positive refractive power, an object-side surface and an image-side surface may be convex. The fifth lens 150 may have positive refractive power, an object-side surface may be concave, and an image-side surface may be convex. The sixth lens 160 may have negative refractive power, an object-side surface and an image-side surface may be concave. The seventh lens 170 may have positive refractive power, an object-side surface and an image-side surface may be convex. The eighth lens 180 may have negative refractive power, an object-side surface may be convex, and an image-side surface may be concave.

According to the first embodiment of the present disclosure, the first lens 110 may be a lens formed of a polymer material, and the second lens 120 to the eighth lens 180 may be lenses formed of a plastic material. For example, the second lens 120 to the eighth lens 180 may be provided as lenses formed of plastic material having different optical characteristics.

Meanwhile, an aspherical coefficient of each lens configuring the optical imaging system 100 according to the first embodiment of the present disclosure is as illustrated in Table 2. According to the first embodiment of the present disclosure, the first lens 110 to the eighth lens 180 may have aspherical surfaces on both surfaces (the object-side surface and the image-side surface).

TABLE 2

| Surface No. | S1 | S2 | S3 | S4 | S5 | S6 | S7 | S8 |
|---|---|---|---|---|---|---|---|---|
| Conic Constant K | −1.968 | 0.010 | 2.713 | 88.818 | 8.634 | 26.634 | 94.622 | 30.414 |
| 4th Coefficient A | 6.121E−03 | 4.725E−02 | 3.072E−03 | −2.675E−03 | −7.531E−03 | −1.044E−02 | −1.083E−02 | 2.229E−02 |
| 6th Coefficient B | −4.211E−03 | −4.233E−01 | −5.390E−02 | 6.958E−02 | −3.178E−02 | −2.360E−02 | 3.622E−02 | −1.833E−01 |
| 8th Coefficient C | 3.172E−02 | 1.908E+00 | 4.468E−01 | −5.282E−01 | 3.801E−01 | 1.687E−01 | −3.314E−01 | 8.665E−01 |
| 10th Coefficient D | −1.332E−01 | −4.939E+00 | −2.122E+00 | 2.384E+00 | −2.384E+00 | −7.146E−01 | 1.750E+00 | −2.610E+00 |
| 12th Coefficient E | 3.216E−01 | 7.414E+00 | 6.415E+00 | −6.926E+00 | 9.074E+00 | 1.908E+00 | −5.912E+00 | 5.156E+00 |
| 14th Coefficient F | −4.902E−02 | −5.224E+00 | −1.312E+01 | 1.366E+01 | −2.273E+01 | −3.270E+00 | 1.344E+01 | −7.027E+00 |
| 16th Coefficient G | 4.917E−01 | −2.161E+00 | 1.882E+01 | −1.887E+01 | 3.921E+01 | 3.544E+00 | −2.123E+01 | 6.796E+00 |
| 18th Coefficient H | −3.279E−01 | 9.101E+00 | −1.928E+01 | 1.858E+01 | −4.773E+01 | −2.185E+00 | 2.371E+01 | −4.723E+00 |
| 20th Coefficient J | 1.416E−01 | −1.027E+01 | 1.418E+01 | −1.309E+01 | 4.135E+01 | 3.462E−01 | −1.885E+01 | 2.358E+00 |
| 22nd Coefficient L | −3.573E−02 | 6.707E+00 | −7.436E+00 | 6.541E+00 | −2.536E+01 | 5.768E−01 | 1.060E+01 | −8.341E−01 |
| 24th Coefficient M | 3.072E−03 | −2.778E+00 | 2.711E+00 | −2.262E+00 | 1.076E+01 | −5.188E−01 | −4.120E+00 | 2.028E−01 |
| 26th Coefficient N | 8.890E−04 | 7.223E−01 | −6.530E−01 | 5.138E−01 | −3.003E+00 | 2.062E−01 | 1.052E+00 | −3.192E−01 |
| 28th Coefficient O | −2.774E−04 | −1.079E−01 | 9.340E−02 | −6.890E−02 | 4.962E−01 | −4.197E−02 | −1.590E−01 | 2.890E−03 |
| 30th Coefficient P | 2.362E−05 | 7.086E−03 | −6.005E−03 | 4.125E−03 | −3.676E−02 | 3.550E−03 | 1.076E−02 | −1.117E−04 |

| Surface No. | S9 | S10 | S11 | S12 | S13 | S14 | S15 |
|---|---|---|---|---|---|---|---|
| Conic Constant K | −82.561 | −12.694 | −2.746 | −3.730 | 25.479 | 93.724 | −7.933 |
| 4th Coefficient A | −1.174E−02 | −6.569E−02 | −1.454E−01 | −5.567E−02 | 1.629E−02 | −1.739E−02 | 1.946E−02 |
| 6th Coefficient B | −1.437E−01 | −1.672E−02 | 1.567E−01 | 3.985E−02 | −5.190E−03 | −2.453E−02 | −3.449E−02 |
| 8th Coefficient C | 8.022E−01 | 4.752E−01 | −1.137E−01 | −7.438E−03 | 5.295E−03 | 1.539E−02 | 1.853E−02 |
| 10th Coefficient D | −2.155E+00 | −1.309E+00 | 3.001E−02 | −1.553E−02 | −4.776E−03 | −5.167E−03 | −6.361E−03 |
| 12th Coefficient E | 3.577E+00 | 1.968E+00 | 2.579E−02 | 1.648E−02 | 2.377E−03 | 1.178E−03 | 1.532E−03 |
| 14th Coefficient F | −4.047E+00 | −1.937E+00 | −3.384E−02 | −8.667E−03 | −7.476E−04 | −1.895E−04 | −2.693E−04 |
| 16th Coefficient G | 3.263E+00 | 1.328E+00 | 1.992E−02 | 2.927E−03 | 1.599E−04 | 2.164E−05 | 3.526E−05 |
| 18th Coefficient H | −1.909E+00 | −6.483E−01 | −7.492E−03 | −6.790E−04 | −2.399E−05 | −1.756E−06 | −3.455E−06 |
| 20th Coefficient J | 8.129E−01 | 2.261E−01 | 1.939E−03 | 1.106E−04 | 2.544E−06 | 1.003E−07 | 2.512E−07 |
| 22nd Coefficient L | −2.491E−01 | −5.555E−02 | −3.500E−04 | −1.262E−05 | −1.896E−07 | −3.947E−09 | −1.328E−08 |
| 24th Coefficient M | 5.348E−02 | 9.308E−03 | 4.336E−05 | 9.878E−07 | 9.685E−09 | 1.024E−10 | 4.928E−10 |
| 26th Coefficient N | −7.627E−03 | −9.986E−04 | −3.517E−06 | −5.055E−08 | −3.228E−10 | −1.598E−12 | −1.212E−11 |
| 28th Coefficient O | 6.485E−04 | 6.046E−05 | 1.682E−07 | 1.522E−09 | 6.320E−12 | 1.209E−14 | 1.767E−13 |
| 30th Coefficient P | −2.487E−05 | −1.503E−06 | −3.595E−09 | −2.047E−11 | −5.511E−14 | −1.795E−17 | −1.153E−15 |

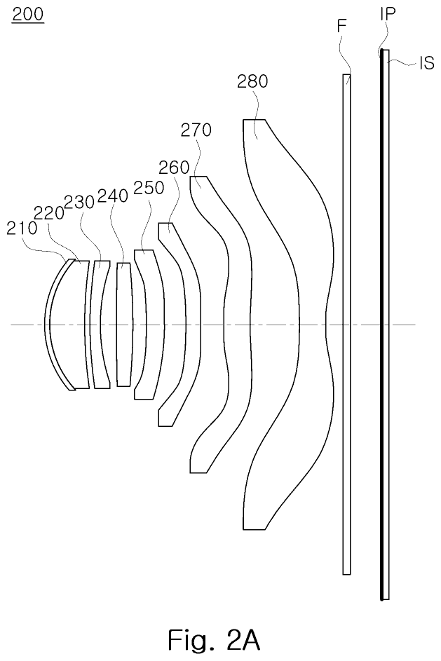

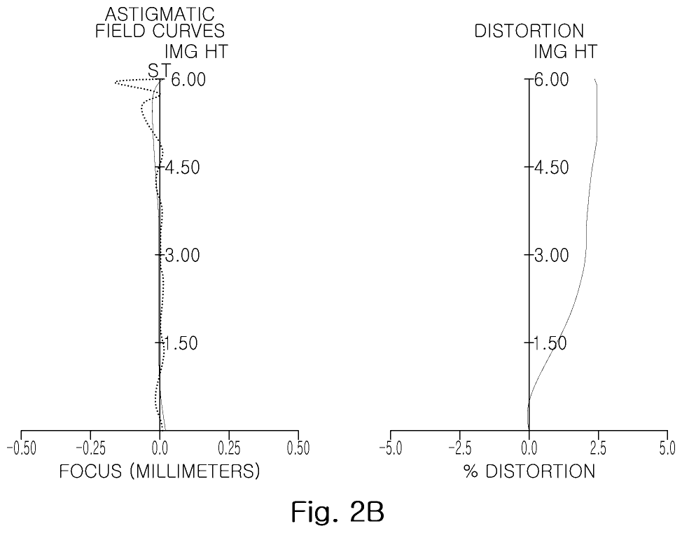

FIG. 2A is a configuration diagram of an optical imaging system according to a second embodiment of the present disclosure, and FIG. 2B is a diagram illustrating aberration characteristics of the optical imaging system illustrated in FIG. 2A.

An optical imaging system 200 according to the second embodiment of the present disclosure may include a first lens 210, a second lens 220, a third lens 230, a fourth lens 240, a fifth lens 250, a sixth lens 260, a seventh lens 270, and an eighth lens 280 sequentially disposed from an object side, and an image sensor IS having a filter F and an imaging plane IP on which a focus is formed.

A total focal length f of the optical imaging system 200 according to the second embodiment of the present disclosure is 6.41 mm, IMG HT is 6.00 mm, and FOV is 85.0°.

The characteristics of each lens configuring the optical imaging system 200 according to the second embodiment of the present disclosure are illustrated in Table 3.

TABLE 3

| Surface | | Curvature | Thickness/ | Refractive | Abbe | Focal |
|---|---|---|---|---|---|---|
| No. | Component | Radius | Distance | Index | No. | length |
| S1 | 1st Lens | 2.2575 | 0.1000 | 1.650 | 38.67 | −37.67 |
| S2 | 2nd Lens | 2.0318 | 0.7426 | 1.544 | 55.99 | 4.42 |
| S3 | | 11.1050 | 0.1000 | | | |
| S4 | 3rd Lens | 15.0528 | 0.2300 | 1.671 | 19.24 | −12.93 |
| S5 | | 5.5093 | 0.3316 | | | |
| S6 | 4th Lens | 26.3222 | 0.3545 | 1.544 | 55.99 | 34.69 |
| S7 | | −67.3688 | 0.2687 | | | |
| S8 | 5th Lens | −62.1388 | 0.3574 | 1.671 | 19.24 | −41.20 |
| S9 | | 50.9815 | 0.4500 | | | |
| S10 | 6th Lens | 30.3954 | 0.3100 | 1.614 | 25.94 | −43.63 |
| S11 | | 14.2579 | 0.5018 | | | |
| S12 | 7th Lens | 4.5293 | 0.5620 | 1.567 | 37.40 | 8.25 |
| S13 | | 114.6636 | 1.0038 | | | |
| S14 | 8th Lens | 10.1580 | 0.5428 | 1.535 | 55.74 | −5.35 |
| S15 | | 2.1970 | 0.4000 | | | |
| S16 | Filter | Infinity | 0.1100 | 1.517 | 64.20 | |
| S17 | | Infinity | 0.6917 | | | |
| S18 | Imaging | Infinity | | | | |
| | Plane | | | | | |

According to the second embodiment of the present disclosure, the first lens 210 may have negative refractive power, an object-side surface may be convex, and an image-side surface may be concave. The second lens 220 may have positive refractive power, an object-side surface may be convex, and an image-side surface may be concave. The third lens 230 may have negative refractive power, an object-side may be convex, and an image-side surface may be concave. The fourth lens 240 may have positive refractive power, an object-side surface and an image-side surface may be convex. The fifth lens 250 may have negative refractive power, an object-side surface and an image-side surface may be concave. The sixth lens 260 may have negative refractive power, an object-side surface may be convex, and an image-side surface may be concave. The seventh lens 270 may have positive refractive power, an object-side surface may be convex, and an image-side surface may be concave. The eighth lens 280 may have negative refractive power, an object-side surface may be convex, and an image-side surface may be concave.

According to the second embodiment of the present disclosure, the first lens 210 may be a lens formed of a polymer material, and the second lens 220 to the eighth lens 280 may be lenses formed of a plastic material. For example, the second lens 220 to the eighth lens 280 may each be provided as a lens formed of a plastic material having optical characteristics different from the adjacently disposed lenses.

Meanwhile, the aspherical coefficients of each lens configuring the optical imaging system 200 according to the second embodiment of the present disclosure are as illustrated in Table 4. According to the second embodiment of the present disclosure, the first lens 210 to the eighth lens 280 may have aspherical surfaces on both surfaces (the object-side surface and the image-side surface).

TABLE 4

| Surface No. | S1 | S2 | S3 | S4 | S5 | S6 | S7 | S8 |
|---|---|---|---|---|---|---|---|---|
| Conic Constant K | −0.510 | −0.473 | 24.074 | 87.885 | 3.659 | 7.302 | −99.000 | −96.366 |
| 4th Coefficient A | 7.600E−03 | −8.660E−03 | 3.966E−03 | 9.595E−03 | 2.845E−03 | −1.628E−02 | −2.764E−02 | −5.204E−02 |
| 6th Coefficient B | −4.911E−02 | 1.232E−02 | 2.895E−03 | −3.046E−02 | 3.428E−02 | −3.139E−03 | 3.382E−02 | 3.235E−02 |
| 8th Coefficient C | 3.276E−01 | −2.771E−03 | −4.728E−02 | 1.715E−01 | −3.250E−01 | −6.332E−03 | −2.112E−01 | −1.696E−01 |
| 10th Coefficient D | −1.230E+00 | 0.000E+00 | 2.189E−01 | −6.555E−01 | 1.720E+00 | 2.271E−01 | 9.823E−01 | 6.987E−01 |
| 12th Coefficient E | 2.987E+00 | 0.000E+00 | −6.005E−01 | 1.698E+00 | −5.783E+00 | −1.323E+00 | −3.157E+00 | −2.134E+00 |
| 14th Coefficient F | −4.930E+00 | 0.000E+00 | 1.097E+00 | −3.047E+00 | 1.323E+01 | 4.129E+00 | 7.131E+00 | 4.642E+00 |
| 16th Coefficient G | 5.693E+00 | 0.000E+00 | −1.398E+00 | 3.871E+00 | −2.128E+01 | −8.130E+00 | −1.146E+01 | −7.198E+00 |
| 18th Coefficient H | −4.673E+00 | 0.000E+00 | 1.268E+00 | −3.527E+00 | 2.449E+01 | 1.076E+01 | 1.323E+01 | 8.004E+00 |
| 20th Coefficient J | 2.737E+00 | 0.000E+00 | −8.232E−01 | 2.309E+00 | −2.023E+01 | −9.828E+00 | −1.099E+01 | −6.377E+00 |
| 22nd Coefficient L | −1.135E+00 | 0.000E+00 | 3.795E−01 | −1.077E+00 | 1.189E+01 | 6.213E+00 | 6.496E+00 | 3.600E+00 |
| 24th Coefficient M | 3.247E−01 | 0.000E+00 | −1.212E−01 | 3.491E−01 | −4.847E+00 | −2.670E+00 | −2.668E+00 | −1.401E+00 |
| 26th Coefficient N | −6.096E−02 | 0.000E+00 | 2.549E−02 | −7.464E−02 | 1.302E+00 | 7.446E−01 | 7.227E−01 | 3.564E−01 |
| 28th Coefficient O | 6.753E−03 | 0.000E+00 | −3.173E−03 | 9.465E−03 | −2.071E−01 | −1.213E−01 | −1.161E−01 | −5.308E−02 |
| 30th Coefficient P | −3.341E−04 | 0.000E+00 | 1.770E−04 | −5.391E−04 | 1.476E−02 | 8.763E−03 | 8.365E−03 | 3.493E−03 |

| Surface No. | S9 | S10 | S11 | S12 | S13 | S14 | S15 |
|---|---|---|---|---|---|---|---|
| Conic Constant K | 54.022 | 13.291 | −27.247 | −14.875 | −99.000 | 2.675 | −8.104 |
| 4th Coefficient A | −4.506E−02 | −6.812E−02 | −1.050E−01 | −1.002E−02 | 6.578E−03 | −1.249E−01 | −6.044E−02 |
| 6th Coefficient B | 3.877E−02 | −6.541E−02 | 5.408E−02 | −3.074E−03 | −2.759E−03 | 4.962E−02 | 2.267E−02 |
| 8th Coefficient C | −1.685E−01 | 4.252E−01 | −3.386E−02 | −9.686E−03 | −5.770E−03 | −1.662E−02 | −6.874E−03 |
| 10th Coefficient D | 5.574E−01 | −1.148E+00 | 2.082E−02 | 1.513E−02 | 5.831E−03 | 4.770E−03 | 1.585E−03 |
| 12th Coefficient E | −1.276E+00 | 1.991E+00 | −9.903E−03 | −1.286E−02 | −3.316E−03 | −1.061E−03 | −2.702E−04 |
| 14th Coefficient F | 2.021E+00 | −2.401E+00 | 1.994E−03 | 7.100E−03 | 1.300E−03 | 1.752E−04 | 3.341E−05 |
| 16th Coefficient G | −2.264E+00 | 2.070E+00 | 1.078E−03 | −2.677E−03 | −3.661E−04 | −2.128E−05 | −2.949E−06 |
| 18th Coefficient H | 1.821E+00 | −1.291E+00 | −1.110E−03 | 6.999E−04 | 7.454E−05 | 1.902E−06 | 1.820E−07 |
| 20th Coefficient J | −1.056E+00 | 5.826E−01 | 4.891E−04 | −1.273E−04 | −1.090E−05 | −1.245E−07 | −7.516E−09 |
| 22nd Coefficient L | 4.376E−01 | −1.883E−01 | −1.312E−04 | 1.600E−05 | 1.130E−06 | 5.897E−09 | 1.838E−10 |
| 24th Coefficient M | −1.263E−01 | 4.239E−02 | 2.221E−05 | −1.363E−06 | −8.091E−08 | −1.965E−10 | −1.367E−12 |
| 26th Coefficient N | 2.410E−02 | −6.303E−03 | −2.286E−06 | 7.506E−08 | 3.810E−09 | 4.368E−12 | −5.861E−14 |
| 28th Coefficient O | −2.728E−03 | 5.557E−04 | 1.284E−07 | −2.415E−09 | −1.063E−10 | −5.810E−14 | 1.803E−15 |
| 30th Coefficient P | 1.384E−04 | −2.197E−05 | −2.934E−09 | 3.448E−11 | 1.332E−12 | 3.495E−16 | −1.636E−17 |

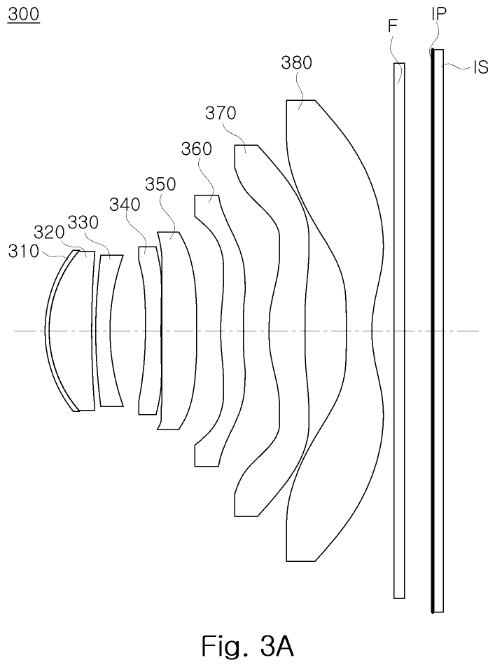

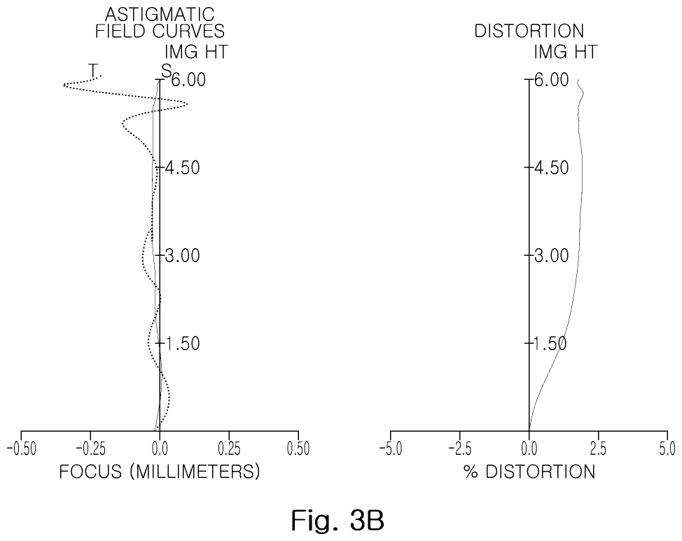

FIG. 3A is a configuration diagram of an optical imaging system according to a third embodiment of the present disclosure, and FIG. 3B is a diagram illustrating aberration characteristics of the optical imaging system illustrated in FIG. 3A.

An optical imaging system 300 according to the third embodiment of the present disclosure may include a first lens 310, a second lens 320, a third lens 330, a fourth lens 340, a fifth lens 350, a sixth lens 360, a seventh lens 370, and an eighth lens 380, sequentially disposed from an object side, and an image sensor IS having a filter F and an imaging plane IP on which a focus is formed.

A total focal length f of the optical imaging system 300 according to the third embodiment of the present disclosure is 6.44 mm, IMG HT is 6.00 mm, and FOV is 84.8°.

The characteristics of each lens configuring the optical imaging system 300 according to the third embodiment of the present disclosure are illustrated in Table 5.

TABLE 5

| Surface | | Curvature | Thickness/ | Refractive | Abbe | Focal |
|---|---|---|---|---|---|---|
| No. | Component | Radius | Distance | Index | No. | length |
| S1 | 1st Lens | 2.9241 | 0.1000 | 1.650 | 55.11 | 96.30 |
| S2 | 2nd Lens | 3.0253 | 0.8651 | 1.544 | 55.95 | 6.51 |
| S3 | | 18.2471 | 0.0678 | | | |
| S4 | 3rd Lens | 8.0295 | 0.3147 | 1.669 | 19.44 | −16.28 |
| S5 | | 4.5726 | 0.7146 | | | |
| S6 | 4th Lens | 22.9832 | 0.3147 | 1.669 | 19.44 | −29.38 |
| S7 | | 10.6042 | 0.0524 | | | |
| S8 | 5th Lens | 28.7263 | 0.6925 | 1.544 | 55.95 | 27.33 |
| S9 | | −30.7936 | 0.4940 | | | |
| S10 | 6th Lens | 6.9930 | 0.4720 | 1.566 | 37.43 | 41.32 |
| S11 | | 9.7046 | 0.5245 | | | |
| S12 | 7th Lens | 4.9397 | 0.7404 | 1.544 | 55.95 | 7.62 |
| S13 | | −25.0651 | 0.8253 | | | |
| S14 | 8th Lens | −29.0345 | 0.5559 | 1.534 | 55.83 | −4.54 |
| S15 | | 2.6724 | 0.4196 | | | |
| S16 | Filter | Infinity | 0.2203 | 1.517 | 64.20 | |
| S17 | | Infinity | 0.5847 | | | |
| S18 | Imaging | Infinity | | | | |
| | Plane | | | | | |

According to the third embodiment of the present disclosure, the first lens 310 may have positive refractive power, an object-side surface may be convex, and an image-side surface may be concave. The second lens 320 may have positive refractive power, an object-side surface may be convex, and an image-side surface may be concave. The third lens 330 may have negative refractive power, an object-side may be convex, and an image-side surface may be concave. The fourth lens 340 may have negative refractive power, an object-side surface of may be convex, and an image-side surface may be concave. The fifth lens 350 may have positive refractive power, an object-side surface and an image-side surface may be convex. The sixth lens 360 may have positive refractive power, an object-side surface may be convex, and an image-side surface may be concave. The seventh lens 370 may have positive refractive power, an object-side surface and an image-side surface may be convex. The eighth lens 380 may have negative refractive power, an object-side surface and an image-side surface may be concave.

According to the third embodiment of the present disclosure, the first lens 310 may be a lens formed of a polymer material, and the second lens 320 to the eighth lens 380 may be lenses formed of a plastic material. For example, the second lens 320 to the eighth lens 380 may each be provided as a lens formed of a plastic material having optical characteristics different from at least a portion of the other lenses.

Meanwhile, the aspherical coefficients of each lens configuring the optical imaging system 300 according to the third embodiment of the present disclosure are as illustrated in Table 6. According to the third embodiment of the present disclosure, the first lens 310 to the eighth lens 380 may have aspherical surfaces on both surfaces (the object-side surface and the image-side surface).

TABLE 6

| Surface No. | S1 | S2 | S3 | S4 | S5 | S6 | S7 | S8 |
|---|---|---|---|---|---|---|---|---|
| Conic Constant K | −0.974 | 1.493 | 12.231 | −5.234 | −1.919 | 68.123 | 11.493 | −65.308 |
| 4th Coefficient A | 8.544E−03 | 1.957E−02 | −1.590E−02 | −2.666E−02 | −1.860E−02 | −3.905E−02 | −3.299E−02 | −3.355E−02 |
| 6th Coefficient B | −8.662E−03 | −2.238E−02 | −1.173E−02 | 2.535E−04 | 4.167E−02 | 8.960E−02 | 2.499E−02 | 1.336E−01 |
| 8th Coefficient C | 4.304E−02 | 8.739E−03 | 1.346E−01 | 1.215E−01 | −1.300E−01 | −4.058E−01 | −1.298E−02 | −3.852E−01 |
| 10th Coefficient D | −1.172E−01 | −1.429E−03 | −3.634E−01 | −3.659E−01 | 3.932E−01 | 1.138E+00 | −9.339E−02 | 7.305E−01 |
| 12th Coefficient E | 1.942E−01 | 0.000E+00 | 5.966E−01 | 6.530E−01 | −8.612E−01 | −2.165E+00 | 2.806E−01 | −9.498E−01 |
| 14th Coefficient F | −2.117E−01 | 0.000E+00 | −6.716E−01 | −7.995E−01 | 1.319E+00 | 2.909E+00 | −4.247E−01 | 8.638E−01 |
| 16th Coefficient G | 1.582E−01 | 0.000E+00 | 5.395E−01 | 6.992E−01 | −1.429E+00 | −2.819E+00 | 4.136E−01 | −5.581E−01 |
| 18th Coefficient H | −8.217E−02 | 0.000E+00 | −3.140E−01 | −4.430E−01 | 1.109E+00 | 1.993E+00 | −2.768E−01 | 2.581E−01 |
| 20th Coefficient J | 2.952E−02 | 0.000E+00 | 1.326E−01 | 2.035E−01 | −6.186E−01 | −1.028E+00 | 1.301E−01 | −8.524E−02 |
| 22nd Coefficient L | −7.115E−03 | 0.000E+00 | −4.025E−02 | −6.704E−02 | 2.462E−01 | 3.824E−01 | −4.291E−02 | 1.978E−02 |
| 24th Coefficient M | 1.069E−03 | 0.000E+00 | 8.542E−03 | 1.542E−02 | −6.824E−02 | −9.986E−02 | 9.722E−03 | −3.119E−03 |
| 26th Coefficient N | −8.199E−05 | 0.000E+00 | −1.203E−03 | −2.349E−03 | 1.252E−02 | 1.737E−02 | −1.441E−03 | 3.135E−04 |
| 28th Coefficient O | 6.032E−07 | 0.000E+00 | 1.011E−04 | 2.128E−04 | −1.366E−03 | −1.805E−03 | 1.256E−04 | −1.767E−05 |
| 30th Coefficient P | 2.334E−07 | 0.000E+00 | −3.828E−06 | −8.683E−06 | 6.719E−05 | 8.485E−05 | −4.880E−06 | 4.048E−07 |

| Surface No. | S9 | S10 | S11 | S12 | S13 | S14 | S15 |
|---|---|---|---|---|---|---|---|
| Conic Constant K | 38.269 | −3.003 | 4.357 | −0.414 | 31.693 | 24.821 | −1.257 |
| 4th Coefficient A | −1.208E−02 | −2.025E−02 | −2.417E−02 | 2.823E−02 | 5.641E−02 | −4.268E−02 | −6.653E−02 |
| 6th Coefficient B | −3.495E−02 | −2.339E−02 | −1.878E−02 | −3.490E−02 | −2.354E−02 | 3.589E−03 | 1.709E−02 |
| 8th Coefficient C | 1.036E−01 | 3.858E−02 | 1.110E−02 | 1.789E−02 | 3.120E−03 | −4.581E−05 | −3.906E−03 |
| 10th Coefficient D | −1.689E−01 | −3.467E−02 | 5.402E−03 | −7.098E−03 | 9.666E−04 | 4.022E−04 | 7.214E−04 |
| 12th Coefficient E | 1.795E−01 | 2.280E−02 | −1.043E−02 | 2.055E−03 | −6.356E−04 | −1.756E−04 | −9.512E−05 |
| 14th Coefficient F | −1.321E−01 | −1.213E−02 | 6.810E−03 | −3.975E−04 | 1.809E−04 | 3.638E−05 | 7.812E−06 |
| 16th Coefficient G | 6.918E−02 | 5.214E−03 | −2.670E−03 | 4.202E−05 | −3.370E−05 | −4.656E−06 | −2.584E−07 |
| 18th Coefficient H | −2.610E−02 | −1.734E−03 | 7.008E0−04 | 1.147E−07 | 4.484E−06 | 4.021E−07 | −1.954E−08 |
| 20th Coefficient J | 7.113E−03 | 4.225E−04 | −1.274E−04 | −7.442E−07 | −4.351E−07 | −2.425E−08 | 3.074E−09 |
| 22nd Coefficient L | −1.390E−03 | −7.152E−05 | 1.612E−05 | 1.161E−07 | 3.062E−08 | 1.027E−09 | −1.941E−10 |
| 24th Coefficient M | 1.913E−04 | 7.847E−06 | −1.398E−06 | −9.452E−09 | −1.523E−09 | −3.002E−11 | 7.190E−12 |
| 26th Coefficient N | −1.789E−05 | −4.931E−07 | 7.932E−08 | 4.508E−10 | 5.075E−11 | 5.779E−13 | −1.619E−13 |
| 28th Coefficient O | 1.046E−06 | 1.265E−08 | −2.658E−09 | −1.194E−11 | −1.017E−12 | −6.602E−15 | 2.061E−15 |
| 30th Coefficient P | −2.978E−08 | 7.419E−11 | 3.993E−11 | 1.360E−13 | 9.241E−15 | 3.392E−17 | −1.142E−17 |

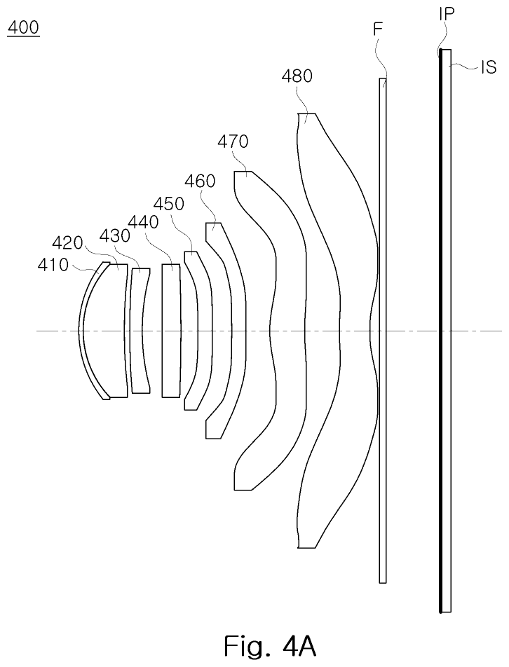

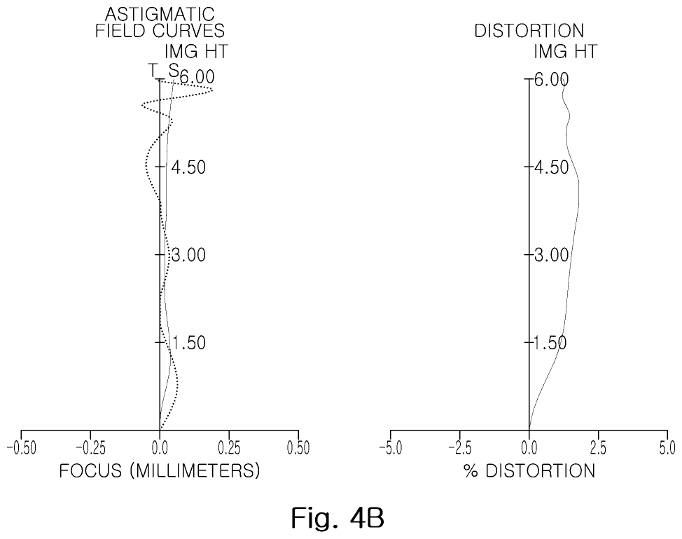

FIG. 4A is a configuration diagram of an optical imaging system according to a fourth embodiment of the present disclosure, and FIG. 4B is a diagram illustrating aberration characteristics of the optical imaging system illustrated in FIG. 4A.

An optical imaging system 400 according to the fourth embodiment of the present disclosure may include a first lens 410, a second lens 420, a third lens 430, a fourth lens 440, a fifth lens 450, a sixth lens 460, a seventh lens 470, and an eighth lens 480, sequentially disposed from an object side, and an image sensor IS having a filter F and an imaging plane IP on which a focus is formed.

A total focal length f of the optical imaging system 400 according to the fourth embodiment of the present disclosure is 6.72 mm, IMG HT is 6.00 mm, and FOV is 82.8°.

The characteristics of each lens configuring the optical imaging system 400 according to the fourth embodiment of the present disclosure are as illustrated in Table 7.

TABLE 7

| Surface | | Curvature | Thickness | Refractive | Abbe | Focal |
|---|---|---|---|---|---|---|
| No. | Component | Radius | or Distance | Index | No. | length |
| S1 | 1st Lens | 2.3631 | 0.1000 | 1.650 | 33.60 | −25.43 |
| S2 | 2nd Lens | 2.0347 | 0.8327 | 1.544 | 55.99 | 4.55 |
| S3 | | 9.6384 | 0.1070 | | | |
| S4 | 3rd Lens | 9.6236 | 0.2676 | 1.671 | 19.24 | −18.77 |
| S5 | | 5.4210 | 0.4018 | | | |
| S6 | 4th Lens | 24.5138 | 0.3848 | 1.544 | 55.99 | −5861.43 |
| S7 | | 24.1927 | 0.3285 | | | |
| S8 | 5th Lens | 49.8609 | 0.3078 | 1.671 | 19.24 | −2499.91 |
| S9 | | 48.3169 | 0.4075 | | | |
| S10 | 6th Lens | 108.8448 | 0.2866 | 1.614 | 25.94 | −47.83 |
| S11 | | 23.2808 | 0.5050 | | | |
| S12 | 7th Lens | 4.2770 | 0.7086 | 1.567 | 37.40 | 9.79 |
| S13 | | 17.1147 | 0.7167 | | | |
| S14 | 8th Lens | 7.4041 | 0.6129 | 1.535 | 55.74 | −6.58 |
| S15 | | 2.3221 | 0.2202 | | | |
| S16 | Filter | Infinity | 0.1178 | 1.517 | 64.20 | |
| S17 | | Infinity | 1.1226 | | | |
| S18 | Imaging | Infinity | | | | |
| | Plane | | | | | |

According to the fourth embodiment of the present disclosure, the first lens 410 may have negative refractive power, an object-side surface may be convex, and an image-side surface may be concave. The second lens 420 may have positive refractive power, an object-side surface may be convex, and an image-side surface may be concave. The third lens 430 may have negative refractive power, an object-side may be convex, and an image-side surface may be concave. The fourth lens 440 may have negative refractive power, an object-side surface of may be convex, and an image-side surface may be concave. The fifth lens 450 may have negative refractive power, an object-side surface may be convex, and an image-side surface may be concave. The sixth lens 460 may have negative refractive power, an object-side surface may be convex, and an image-side surface may be concave. The seventh lens 470 may have positive refractive power, an object-side surface may be convex, and an image-side surface may be concave. The eighth lens 480 may have negative refractive power, an object-side surface may be convex, and an image-side surface may be concave.

According to the fourth embodiment of the present disclosure, the first lens 410 may be a lens formed of a polymer material, and the second lens 420 to the eighth lens 480 may be lenses formed of a plastic material. For example, the second lens 420 to the eighth lens 480 may each be provided as a lens formed of a plastic material having optical characteristics different from at least the adjacently disposed lenses.

Meanwhile, the aspherical coefficients of each lens configuring the optical imaging system 400 according to the fourth embodiment of the present disclosure are as illustrated in Table 8. According to the fourth embodiment of the present disclosure, the first lens 410 to the eighth lens 480 may have aspherical surfaces on both surfaces (the object-side surface and the image-side surface).

TABLE 8

| Surface No. | S1 | S2 | S3 | S4 | S5 | S6 | S7 | S8 |
|---|---|---|---|---|---|---|---|---|
| Conic Constant K | −0.576 | −1.015 | −14.744 | 3.388 | 2.874 | −2.922 | −86.330 | 91.342 |
| 4th Coefficient A | −4.809E−03 | −4.727E−03 | −1.378E−02 | −1.267E−02 | −3.128E−02 | −1.400E−02 | −1.368E−02 | −7.399E−02 |
| 6th Coefficient B | 3.331E−02 | 1.027E−02 | 2.305E−02 | −8.746E−02 | 1.822E−01 | −2.271E−02 | −1.773E−01 | 2.688E−01 |
| 8th Coefficient C | −4.295E−02 | −3.099E−04 | −1.131E−01 | 5.534E−01 | −9.382E−01 | −1.032E−01 | 1.246E+00 | −1.283E+00 |
| 10th Coefficient D | −1.361E−01 | −3.683E−04 | 4.373E−01 | −1.824E+00 | 3.008E+00 | 1.110E+00 | −5.052E+00 | 3.828E+00 |
| 12th Coefficient E | 7.231E−01 | 0.000E+00 | −1.061E+00 | 3.985E+00 | −5.690E+00 | −4.319E+00 | 1.344E+01 | −7.851E+00 |
| 14th Coefficient F | −1.545E+00 | 0.000E+00 | 1.710E+00 | −6.087E+00 | 5.579E+00 | 1.011E+01 | −2.480E+01 | 1.020E+01 |
| 16th Coefficient G | 1.993E+00 | 0.000E+00 | −1.911E+00 | 6.670E+00 | −4.407E−03 | −1.539E+01 | 3.273E+01 | −9.406E+00 |
| 18th Coefficient H | −1.708E+00 | 0.000E+00 | 1.513E+00 | −5.311E+00 | −7.776E+00 | 1.766E+01 | −3.133E+01 | 5.820E+00 |
| 20th Coefficient J | 1.006E+00 | 0.000E+00 | −8.543E−01 | 3.078E+00 | 1.127E+01 | −1.397E+01 | 2.177E+01 | −2.233E+00 |
| 22nd Coefficient L | −4.100E−01 | 0.000E+00 | 3.417E−01 | −1.284E+00 | −8.766E+00 | 7.842E+00 | −1.086E+01 | 3.737E−01 |
| 24th Coefficient M | 1.136E−01 | 0.000E+00 | −9.455E−02 | 3.758E−01 | 4.230E+00 | −3.056E+00 | 3.786E+00 | 8.220E−02 |
| 26th Coefficient N | −2.040E−02 | 0.000E+00 | 1.721E−02 | −7.314E−02 | −1.268E+00 | 7.858E−01 | −8.752E−01 | −5.967E−02 |
| 28th Coefficient O | 2.143E−03 | 0.000E+00 | −1.852E−03 | 8.498E−03 | 2.172E−01 | −1.198E−01 | 1.204E−01 | 1.288E−02 |
| 30th Coefficient P | −9.983E−05 | 0.000E+00 | 8.935E−05 | −4.457E−04 | −1.630E−02 | 8.206E−03 | −7.457E−03 | −1.042E−03 |

| Surface No. | S9 | S10 | S11 | S12 | S13 | S14 | S15 |
|---|---|---|---|---|---|---|---|
| Conic Constant K | 67.134 | 70.112 | −10.649 | −14.977 | −90.132 | −15.802 | −7.769 |
| 4th Coefficient A | −5.136E−02 | −7.124E−02 | −8.179E−02 | 1.968E−03 | 7.304E−03 | −1.084E−01 | −5.774E−02 |
| 6th Coefficient B | 9.086E−02 | 1.800E−02 | −3.029E−02 | −2.187E−02 | −2.367E−03 | 4.387E−02 | 2.066E−02 |
| 8th Coefficient C | −3.296E−01 | −3.112E−02 | 1.513E−01 | 1.249E−02 | −8.945E−03 | −1.687E−02 | −6.405E−03 |
| 10th Coefficient D | 8.097E−01 | 2.181E−01 | −2.315E−01 | −5.300E−03 | 8.422E−03 | 5.574E−03 | 1.512E−03 |
| 12th Coefficient E | −1.366E+00 | −5.372E−01 | 2.257E−01 | 1.524E−03 | −4.160E−03 | −1.302E−03 | −2.492E−04 |
| 14th Coefficient F | 1.603E+00 | 7.473E−01 | −1.520E−01 | −1.939E−04 | 1.359E−03 | 2.088E−04 | 2.700E−05 |
| 16th Coefficient G | −1.334E+00 | −6.789E−01 | 7.241E−02 | −5.465E−05 | −3.144E−04 | −2.343E−05 | −1.680E−06 |
| 18th Coefficient H | 7.949E−01 | 4.252E−01 | −2.461E−02 | 3.363E−05 | 5.267E−05 | 1.868E−06 | 1.992E−08 |
| 20th Coefficient J | −3.380E−01 | −1.873E−01 | 5.966E−03 | −8.066E−06 | −6.419E−06 | −1.063E−07 | 6.283E−09 |
| 22nd Coefficient L | 1.006E−01 | 5.798E−02 | −1.022E−03 | 1.129E−06 | 5.635E−07 | 4.276E−09 | −6.075E−10 |
| 24th Coefficient M | −2.006E−02 | −1.235E−02 | 1.206E−04 | −9.887E−08 | −3.471E−08 | −1.182E−10 | 2.882E−11 |
| 26th Coefficient N | 2.450E−03 | 1.723E−03 | −9.332E−06 | 5.347E−09 | 1.424E−09 | 2.122E−12 | −7.914E−13 |
| 28th Coefficient O | −1.485E−04 | −1.417E−04 | 4.254E−07 | −1.641E−10 | −3.495E−11 | −2.201E−14 | 1.203E−14 |
| 30th Coefficient P | 1.958E−06 | 5.201E−06 | −8.662E−09 | 2.191E−12 | 3.884E−13 | 9.824E−17 | −7.858E−17 |

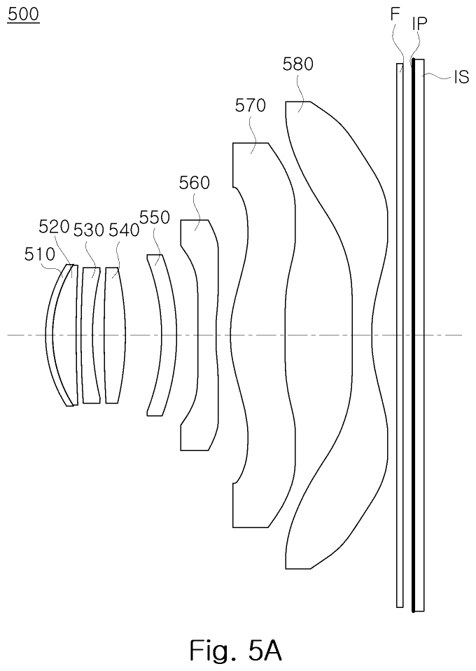

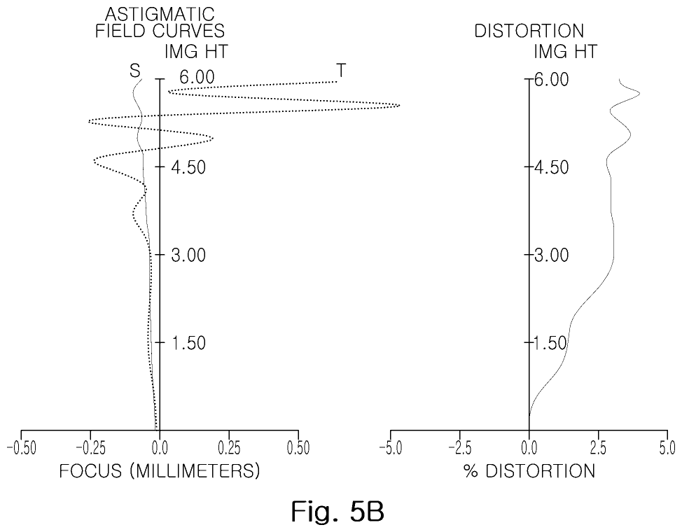

FIG. 5A is a configuration diagram of an optical imaging system according to a fifth embodiment of the present disclosure, and FIG. 5B is a diagram illustrating aberration characteristics of the optical imaging system illustrated in FIG. 5A.

An optical imaging system 500 according to the fifth embodiment of the present disclosure may include a first lens 510, a second lens 520, a third lens 530, a fourth lens 540, a fifth lens 550, a sixth lens 560, a seventh lens 570, and an eighth lens 580, sequentially disposed from an object side, and an image sensor IS having a filter F and an imaging plane IP on which a focus is formed.

A total focal length f of the optical imaging system 500 according to the fifth embodiment of the present disclosure is 6.15 mm, IMG HT is 6.00 mm, and FOV is 86.8°.

The characteristics of each lens configuring the optical imaging system 500 according to the fifth embodiment of the present disclosure are illustrated in Table 9.

TABLE 9

| Surface | | Curvature | Thickness | Refractive | | Focal |
|---|---|---|---|---|---|---|
| No. | Component | Radius | or Distance | Index | Abbe No. | length |
| S1 | 1st Lens | 2.9120 | 0.1000 | 1.650 | 21.14 | 29.14 |
| S2 | 2nd Lens | 3.3875 | 0.4970 | 1.497 | 81.56 | 7.80 |
| S3 | | 25.0690 | 0.1000 | | | |
| S4 | 3rd Lens | 35.9001 | 0.2100 | 1.618 | 25.05 | −10.54 |
| S5 | | 5.5482 | 0.2414 | | | |
| S6 | 4th Lens | 11.9968 | 0.4468 | 1.585 | 32.86 | 11.27 |
| S7 | | −14.6553 | 0.7451 | | | |
| S8 | 5th Lens | −9.4186 | 0.3143 | 1.565 | 39.90 | 32.20 |
| S9 | | −6.2920 | 0.4438 | | | |
| S10 | 6th Lens | −127.3623 | 0.3761 | 1.635 | 23.96 | −6.00 |
| S11 | | 3.9649 | 0.2990 | | | |
| S12 | 7th Lens | 2.6471 | 1.1140 | 1.567 | 37.40 | 5.38 |
| S13 | | 16.2493 | 1.3699 | | | |
| S14 | 8th Lens | 34.0669 | 0.4157 | 1.535 | 55.74 | −6.28 |
| S15 | | 3.0568 | 0.2799 | | | |
| S16 | Filter | Infinity | 0.1540 | 1.517 | 64.20 | |
| S17 | | Infinity | 0.3931 | | | |
| S18 | Imaging | Infinity | | | | |
| | Plane | | | | | |

According to the fifth embodiment of the present disclosure, the first lens 510 may have positive refractive power, an object-side surface may be convex, and an image-side surface may be concave. The second lens 520 may have positive refractive power, an object-side surface may be convex, and an image-side surface may be concave. The third lens 530 may have negative refractive power, an object-side may be convex, and an image-side surface may be concave. The fourth lens 540 may have positive refractive power, an object-side surface and an image-side surface may be convex. The fifth lens 550 may have positive refractive power, an object-side surface may be concave, and an image-side surface may be convex. The sixth lens 560 may have negative refractive power, an object-side surface and an image-side surface may be concave. The seventh lens 570 may have positive refractive power, an object-side surface may be convex, and an image-side surface may be concave. The eighth lens 580 may have negative refractive power, an object-side surface may be convex, and an image-side surface may be concave.

According to the fifth embodiment of the present disclosure, the first lens 510 may be a lens formed of a polymer material, the second lens 520 is a lens formed of a glass material, and the third lens 530 to the eighth lens 580 may be lenses formed of a plastic material. For example, the third lens 530 to the eighth lens 580 may be provided as lenses formed of a plastic material having different optical characteristics.

Meanwhile, the aspherical coefficients of each lens configuring the optical imaging system 500 according to the fifth embodiment of the present disclosure are illustrated in Table 10. According to the fifth embodiment of the present disclosure, the first lens 510 to the eighth lens 580 may have aspherical surfaces on both surfaces (the object-side surface and the image-side surface).

TABLE 10

| Surface No. | S1 | S2 | S3 | S4 | S5 | S6 | S7 | S8 |
|---|---|---|---|---|---|---|---|---|
| Conic Constant K | −1.681 | 1.791 | −23.230 | 39.730 | 8.527 | 27.375 | 94.638 | 30.952 |
| 4th Coefficient A | −8.681E−03 | 2.714E−02 | −1.960E−02 | −6.183E−03 | −1.635E−02 | −6.808E−04 | −5.758E−03 | 2.820E−03 |
| 6th Coefficient B | 2.790E−01 | 4.346E−01 | 1.346E−01 | 1.011E−01 | 1.655E−01 | −1.046E−01 | −9.870E−03 | 6.143E−02 |
| 8th Coefficient C | −1.789E+00 | −3.894E+00 | −5.681E−01 | −4.547E−01 | −1.140E+00 | 5.486E−01 | −5.307E−02 | −3.807E−01 |
| 10th Coefficient D | 6.640E+00 | 1.700E+01 | 1.576E+00 | 1.282E+00 | 4.467E+00 | −1.856E+00 | 4.831E−01 | 1.196E+00 |
| 12th Coefficient E | −1.598E+01 | −4.586E+01 | −2.879E+00 | −2.486E+00 | −1.146E+01 | 4.009E+00 | −1.896E+00 | −2.550E+00 |
| 14th Coefficient F | 2.639E+01 | 8.300E+01 | 3.448E+00 | 3.451E+00 | 2.025E+01 | −5.579E+00 | 4.555E+00 | 3.810E+00 |
| 16th Coefficient G | −3.087E+01 | −1.051E+02 | −2.567E+00 | −3.500E+00 | −2.540E+01 | 4.859E+00 | −7.313E+00 | −4.057E+00 |
| 18th Coefficient H | 2.601E+01 | 9.515E+01 | 9.012E−01 | 2.603E+00 | 2.292E+01 | −2.218E+00 | 8.159E+00 | 3.113E+00 |
| 20th Coefficient J | −1.585E+01 | −6.198E+01 | 2.674E−01 | −1.405E+00 | −1.493E+01 | −1.418E−01 | −6.428E+00 | −1.725E+00 |
| 22nd Coefficient L | 6.922E+00 | 2.884E+01 | −5.056E−01 | 5.359E−01 | 6.945E+00 | 8.973E−01 | 3.570E+00 | 6.847E−01 |
| 24th Coefficient M | −2.113E00 | −9.359E+00 | 2.862E−01 | −1.370E−01 | −2.247E+00 | −5.959E−01 | −1.369E+00 | −1.899E−01 |
| 26th Coefficient N | 4.279E−01 | 2.012E+00 | −8.804E−02 | 2.112E−02 | 4.790E−01 | 2.021E−01 | 3.455E−01 | 3.502E−02 |
| 28th Coefficient O | −5.168E−02 | −2.577E−01 | 1.476E−02 | −1.516E−03 | −6.028E−02 | −3.655E−02 | −5.166E−02 | −3.864E−03 |
| 30th Coefficient P | 2.816E−03 | 1.488E−02 | −1.062E−03 | 8.191E−06 | 3.375E−03 | 2.801E−03 | 3.469E−03 | 1.935E−04 |

| Surface No. | S9 | S10 | S11 | S12 | S13 | S14 | S15 |
|---|---|---|---|---|---|---|---|
| Conic Constant K | −79.445 | 99.000 | −1.981 | −4.494 | −42.706 | −38.340 | −8.485 |
| 4th Coefficient A | −1.650E−02 | −6.690E−02 | −1.636E−01 | −4.866E−02 | 2.758E−02 | −2.798E−03 | 2.608E−02 |
| 6th Coefficient B | 3.862E−02 | 1.109E−01 | 1.993E−01 | 4.131E−02 | −1.424E−02 | −3.652E−02 | −3.744E−02 |
| 8th Coefficient C | −6.318E−02 | −8.612E−02 | −2.187E−01 | −3.372E−02 | 5.361E−03 | 2.670E−02 | 1.842E−02 |
| 10th Coefficient D | −3.338E−02 | −3.993E−02 | 2.024E−01 | 2.261E−02 | −1.800E−03 | −1.044E−02 | −5.331E−03 |
| 12th Coefficient E | 3.082E−01 | 2.069E−01 | −1.476E−01 | −1.183E−02 | 4.829E−04 | 2.612E−03 | 1.021E−03 |
| 14th Coefficient F | −6.639E−01 | −2.985E−01 | 8.167E−02 | 4.677E−03 | −9.612E−05 | −4.454E−04 | −1.361E−04 |
| 16th Coefficient G | 8.503E−01 | 2.609E−01 | −3.386E−02 | −1.376E−03 | 1.366E−05 | 5.339E−05 | 1.293E−05 |
| 18th Coefficient H | −7.285E−01 | −1.546E−01 | 1.047E−02 | 2.991E−04 | −1.346E−06 | −4.571E−06 | −8.813E−07 |
| 20th Coefficient J | 4.321E−01 | 6.426E−02 | −2.398E−03 | −4.759E−05 | 8.774E−08 | 2.805E−07 | 4.279E−08 |
| 22nd Coefficient L | −1.781E−01 | −1.878E−02 | 4.003E−04 | 5.453E−06 | −3.374E−09 | −1.224E−08 | −1.446E−09 |
| 24th Coefficient M | 5.013E−052 | 3.788E−03 | −4.727E−05 | −4.366E−07 | 4.505E−11 | 3.708E−10 | 3.249E−11 |
| 26th Coefficient N | −9.187E−03 | −5.022E−04 | 3.738E−06 | 2.315E−08 | 1.880E−12 | −7.416E−12 | −4.432E−13 |
| 28th Coefficient O | 9.881E−04 | 3.939E−05 | −1.775E−07 | −7.289E−10 | −8.964E−14 | 8.808E−14 | 2.993E−15 |
| 30th Coefficient P | −4.731E−05 | −1.385E−06 | 3.823E−09 | 1.031E−11 | 1.148E−15 | −4.708E−16 | −4.685E−18 |

Table 11 illustrates conditional expression values of an optical imaging system according to embodiments of the present disclosure.

TABLE 11

| Conditional | 1^{st} | 2^{nd} | 3^{rd} | 4^{th} | 5^{th} |
|---|---|---|---|---|---|
| Expression | Embodiment | Embodiment | Embodiment | Embodiment | Embodiment |
| \| f1/v1 − f2/v2 \| | 2.270 | 1.053 | 1.631 | 0.838 | 1.283 |
| v1 − v2 | −21.22 | −17.32 | −0.84 | −22.39 | −60.42 |
| n1 − n2 | 0.033 | 0.106 | 0.106 | 0.106 | 0.153 |
| f1/f/10 | −1.418 | −0.588 | 1.495 | −0.378 | 0.474 |
| f2/f | 0.815 | 0.690 | 1.011 | 0.676 | 1.268 |
| f3/f | −1.529 | −2.017 | −2.527 | −2.793 | −1.715 |
| f4/f/100 | 0.018 | 0.054 | −0.046 | −8.721 | 0.018 |
| f5/f/100 | 0.050 | −0.064 | 0.042 | −3.720 | 0.052 |
| f6/f | −0.996 | −6.810 | 6.413 | −7.116 | −0.974 |
| f7/f | 0.924 | 1.287 | 1.183 | 1.457 | 0.875 |
| f8/f | −0.923 | −0.834 | −0.704 | −0.978 | −1.022 |
| TTL/(2XIMG HT) | 0.625 | 0.588 | 0.663 | 0.619 | 0.625 |
| f/EPD | 1.986 | 2.252 | 1.859 | 2.293 | 1.998 |
| TTL/f | 1.237 | 1.101 | 1.235 | 1.105 | 1.220 |
| BFL/f | 0.145 | 0.188 | 0.190 | 0.217 | 0.135 |

In one or more embodiments, an optical imaging system may achieve high resolution while having a small overall length.

In one or more embodiments, high resolution may be implemented while reducing the size. In addition, chromatic aberration may be improved.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens having refractive power, a second lens having positive refractive power, a third lens having negative refractive power, a fourth lens, a fifth lens, a sixth lens, a seventh lens, and an eighth lens, sequentially disposed from an object side,
wherein the first lens and the second lens are bonded together, and
wherein 0≤|f1/v1−f2/v2|<3 is satisfied,
where f1 is a focal length of the first lens, v1 is an Abbe number of the first lens, f2 is a focal length of the second lens, and v2 is an Abbe number of the second lens.

2. The optical imaging system of claim 1, wherein the Abbe number of the first lens is lower than the Abbe number of the second lens.

3. The optical imaging system of claim 1, wherein a refractive index of the first lens is higher than a refractive index of the second lens.

4. The optical imaging system of claim 1, wherein the third lens has a convex object-side surface and a concave image-side surface.

5. The optical imaging system of claim 1, wherein the fourth lens has a convex object-side surface, and the sixth lens has a concave image-side surface.

6. The optical imaging system of claim 1, wherein the seventh lens has positive refractive power and a convex object-side surface.

7. The optical imaging system of claim 1, wherein the eighth lens has negative refractive power and a convex object-side surface.

8. The optical imaging system of claim 1, wherein 1<TTL/f<1.3 is satisfied,
where f is a total focal length of the optical imaging system, and TTL is a distance on an optical axis from an object-side surface of the first lens to an imaging plane.

9. The optical imaging system of claim 1, wherein 0.5<TTL/(2×IMG HT)<0.8 is satisfied,
where IMG HT is a half of a diagonal length of an imaging plane, and TTL is a distance along an optical axis from an object-side surface of the first lens to an imaging plane.

10. An optical imaging system, comprising:
a first lens, a second lens, a third lens, a fourth lens, a fifth lens, a sixth lens, a seventh lens, and an eighth lens, sequentially arranged from an object side,
wherein the first lens and the second lens are bonded together, and
wherein either one or both of v1−v2<0 and 0<n1−n2 are satisfied,
where v1 is an Abbe number of the first lens, v2 is an Abbe number of the second lens, n1 is a refractive index of the first lens, and n2 is a refractive index of the second lens.

11. The optical imaging system of claim 10, wherein 0<f2/f<2 is satisfied, where f is a total focal length of the optical imaging system, and f2 is a focal length of the second lens.

12. The optical imaging system of claim 10, wherein −5<f3/f<−1 is satisfied,
where f is a total focal length of the optical imaging system, and f3 is a focal length of the third lens.

13. The optical imaging system of claim 10, wherein −10<f4/f/100<1 is satisfied,
where f is a total focal length of the optical imaging system, and f4 is a focal length of the fourth lens.

14. The optical imaging system of claim 10, wherein −5<f5/f/100<1 is satisfied,
where f is a total focal length of the optical imaging system, and f5 is a focal length of the fifth lens.

15. The optical imaging system of claim 10, wherein 0<f7/f<2 is satisfied,
where f is a total focal length of the optical imaging system, and f7 is a focal length of the seventh lens.

16. The optical imaging system of claim 10, wherein −2<f8/f<0 is satisfied,
where f is a total focal length of the optical imaging system, and f8 is a focal length of the eighth lens.
